(19) United States
(12) Patent Application Publication
(10) Pub. No.: US 2013/0329147 A1
(43) Pub. Date: Dec. 12, 2013

(54) LIQUID CRYSTAL PANEL AND LIQUID CRYSTAL DISPLAY

(71) Applicants: Mitsuhiro Murata, Osaka-shi (JP); Yosuke Iwata, Osaka-shi (JP)

(72) Inventors: Mitsuhiro Murata, Osaka-shi (JP); Yosuke Iwata, Osaka-shi (JP)

(73) Assignee: sharp Kabushiki Kaisha, Osaka-shi Osaka (JP)

(21) Appl. No.: 13/977,266

(22) PCT Filed: Dec. 21, 2011
(86) PCT No.: PCT/JP2011/079726

§ 371 Date: Jun. 28, 2013

(30) Foreign Application Priority Data
Dec. 28, 2010 (JP) 2010-293851

(51) Int. Cl. G02F 1/1343

(52) U.S. Cl. CPC G02F 1/134309
USPC 349/33

(57) ABSTRACT

The present invention provides a liquid crystal panel that can improve viewing angle characteristics and a liquid crystal display. The present invention is a liquid crystal panel of a vertical alignment type and includes a first substrate, a second substrate facing the first substrate, and a liquid crystal layer that is sandwiched between the first substrate and the second substrate and that includes liquid crystal molecules. The first substrate includes a first electrode including a plurality of first line-shaped portions arranged side by side with a gap. The first substrate or the second substrate includes a second electrode. The liquid crystal layer is driven by an electric field generated by at least the first electrode and the second electrode. D/d<3 is satisfied where D is the distance between center lines of the plurality of first line-shaped portions and d is the cell thickness of the liquid crystal panel.

### TECHNICAL FIELD

The present invention relates to a liquid crystal panel and a liquid crystal display. More specifically, the present invention relates to a liquid crystal panel with excellent viewing angle characteristics and a liquid crystal display with the liquid crystal panel.

### BACKGROUND ART

A liquid crystal panel is configured by sandwiching liquid crystal display elements between a pair of glass substrates or the like. Liquid crystal displays with such liquid display panels are used in applications such as mobile applications, various monitors, televisions, or the like because of their thin shape, light weight, and low power consumption. Liquid crystal displays are indispensable in daily life and businesses. In recent years, liquid crystal displays are widely adopted in applications such as projecting-type display devices (projectors), electronic books, photo frames, IA (industrial appliances), PC (personal computers) applications, or the like. In these applications, liquid crystal panels in various modes with different electrode arrangements and/or substrate designs are under study in order to change the optical characteristics of a liquid crystal layer.

For example, as a liquid crystal display for a projector, a liquid crystal display with a plurality of liquid crystal panels is disclosed, in which at least one liquid crystal panel is used in a normally black mode, and the remaining liquid crystal panel or panels are used in a normally white mode (for example, see PTL 1).

### CITATION LIST

### Patent Literature

PTL 1: Japanese Unexamined Patent Application Publication No. 2005-321585

### SUMMARY OF INVENTION

### Technical Problem

However, a liquid crystal display in which the initial alignment state of liquid crystal molecules is vertical alignment, that is, a liquid crystal display in a vertical alignment (VA) mode, leaves room for innovations in the point of improving viewing angle characteristics (such as γ shift). Since liquid crystal molecules are bar shaped, if the liquid crystal display is observed from the front and diagonal directions, the polarization states of light passing through the liquid crystal panel are different. That is, the transmittance is different in the front and diagonal directions. As a result, a voltage-transmittance curve (hereinafter may also be referred to as a VT curve) changes in the front and diagonal directions, and the γ curve in the diagonal direction rises, compared with the γ curve in the front direction. That is, luminance increases in the diagonal direction, compared with the front direction. Therefore, “whitening” occurs in the diagonal direction. Note that “whitening” is a phenomenon in which, if the viewing angle direction is changed from the front to the diagonal in a state where relatively dark display with low resolution is performed, display that should seem dark appears to be whitish.

In view of the above-described circumstances, an object of the present invention is to provide a liquid crystal panel that can improve viewing angle characteristics and a liquid crystal display.

### Solution to Problem

The inventors of the present invention conducted various studies on a liquid crystal panel that can improve viewing angle characteristics and a liquid crystal display and focused on a vertical alignment liquid crystal panel. The inventors conceived a solution to the above-described problem by forming, on at least one of two types of electrodes that drive a liquid crystal layer, a plurality of line-shaped portions arranged side by side with a gap, and finding that the γ curve in the diagonal direction can be made closer to the γ curve in the front direction by reducing the ratio D/d between the distance D between the center lines of the plurality of line-shaped portions and the cell thickness d of the liquid crystal panel. Accordingly, the inventors attained the present invention.

That is, a first aspect of the present invention is a liquid crystal panel of a vertical alignment type. The liquid crystal panel (hereinafter may also be referred to as the liquid crystal panel of the present invention) includes a first substrate, a second substrate facing the first substrate, and a liquid crystal layer that is sandwiched between the first substrate and the second substrate and that includes liquid crystal molecules. The first substrate includes a first electrode including a plurality of first line-shaped portions arranged side by side with a gap. The first substrate or the second substrate includes a second electrode. The liquid crystal layer is driven by an electric field generated by at least the first electrode and the second electrode. D/d<3 is satisfied where D is the distance between center lines of the plurality of first line-shaped portions and d is the cell thickness of the liquid crystal panel.

When D/d is greater than or equal to 3, the viewing angle characteristics may not be improved.

The configuration of the liquid crystal panel of the present invention is not particularly limited by other elements as long as the configuration is formed by including the above elements as essential elements. The first electrode may include portions other than the plurality of first line-shaped portions or may include only the plurality of first line-shaped portions. The first electrode normally includes portions other than the first line-shaped portions.

Preferable configurations of the liquid crystal panel of the present invention will be described in detail below.

It is necessary for the liquid crystal panel of the present invention to satisfy D/d<3. It is preferable that D/d≦1 be satisfied, and it is more preferable that D/d≦0.83 be satisfied. When D/d is less than or equal to 1, the γ shift can be significantly improved. More specifically, when D/d is less than or equal to 1, the γ curve in the diagonal direction can be concaved toward the γ curve in the front direction than a straight line connecting the luminance ratio of the 0 gradation level and the luminance ratio of the 255 gradation level, that is, a straight line at γ=1. When D/d is less than or equal to 0.83, the γ curve in the diagonal direction can be almost superimposed on the γ curve in the front direction.

When the number of the plurality of line-shaped portions is three or greater, there are two or more distances D. In this case, the two or more distances D may be different or the same. In the former case, a plurality of regions with different distances D can be formed in the liquid crystal layer, and the VT curve can be made different in these regions. Therefore, the viewing angle characteristics can be more effectively improved. In the latter case, the distance D may also be referred to as the pitch P.

It is preferable that the liquid crystal molecules be symmetrically aligned with respect to a certain face (virtual face) upon application of voltage. Accordingly, complementary alignment compensation can be more effectively achieved. The face normally exists on the center between the plurality of line-shaped portions or the center lines of the plurality of line-shaped portions.

A preferable electrode structure of the liquid crystal panel of the present invention may be structures (A) and (B) described below. According to these structures, the liquid crystal molecules can be easily aligned symmetrically with respect to a certain face upon application of voltage.

In the structure (A), the first substrate includes the second electrode; the second electrode includes a plurality of second line-shaped portions arranged side by side with a gap; and the first line-shaped portions and the second line-shaped portions are alternately arranged.

In the structure (B), the first substrate includes the second electrode and an insulating layer provided between the first electrode and the second electrode; the second electrode is planar; the second substrate includes a planar third electrode; and the second electrode is superimposed on the gap.

A preferable configuration of the structure (A) may be configurations (A-1) to (A-3) described below.

In the configuration (A-1), the first electrode and the second electrode each include a comblike shape. At this time, the first line-shaped portions and the second line-shaped portions correspond to teeth. According to this configuration, an electric field can be formed at a high density between the first electrode and the second electrode, and the liquid crystal molecules can be highly accurately controlled.

In the configuration (A-2), the dielectric constant anisotropy of the liquid crystal molecules is positive. According to this configuration, the alignment of the liquid crystal molecules can be more effectively tilted in the structure (A). Therefore, the transmittance can be improved.

In the configuration (A-3), the liquid crystal panel of the present invention satisfies D/d>1.5. According to this configuration, the disturbance of desired alignment of the liquid crystal molecules can be suppressed in the structure (A).

A preferable configuration of the structure (B) may be configurations (B-1) and (A-2) described below.

In the configuration (B-1), the first electrode includes a comblike shape. At this time, the first line-shaped portions correspond to teeth. According to this configuration, an electric field can be formed at a high density between the first electrode and the second electrode, and the liquid crystal molecules can be highly accurately controlled.

The comblike shape means a shape in which a plurality of lines (teeth) protrude from one line, and the shapes of the individual teeth are not particularly limited to straight lines.

In the configuration (B-2), the dielectric constant anisotropy of the liquid crystal molecules is negative. According to this configuration, the alignment of the liquid crystal molecules can be more effectively tilted in the structure (B). Therefore, the transmittance can be improved.

The liquid crystal panel of the present invention may further include a circular polarizing plate or a linear polarizing plate. In the former case, the transmittance can be improved. In the latter case, the viewing angle characteristics can be further improved. A general liquid crystal panel with a circular polarizing plate leaves room for improvement of viewing angle characteristics. In contrast, according to the liquid crystal panel of the present invention, the viewing angle characteristics can be improved. Therefore, when the liquid crystal panel of the present invention further includes a circular polarizing plate, both a wide viewing angle and a high transmittance can be achieved.

It is preferable that the optical axis of the circular polarizing plate be orthogonal or parallel to the plurality of first line-shaped portions. Accordingly, when D/d is very small (such as D/d<1), the γ shift can be more effectively improved, compared with a configuration in which the optical axis of the circular polarizing plate is diagonally arranged with respect to the first line-shaped portions. Orthogonal may not necessarily be the case where an angle defined by the optical axis and the first line-shaped portions is 90° and may be substantially orthogonal. Specifically, it is preferable that the angle defined by the two be greater than or equal to 86° (more preferably 88°). Also, parallel may not necessarily be the case where an angle defined by the optical axis and the first line-shaped portions is 0° and may be substantially parallel. Specifically, it is preferable that the angle defined by the two be less than or equal to 4° (more preferably 2°).

The type and structure of the circular polarizing plate are not particularly limited. For example, a normal circular polarizing plate used in the field of displays can be used. Preferably, a multilayer body including a λ/4 plate and a linear polarizing plate (linear polarizer) may be used. Alternatively, a structure with a helical structure at an optical pitch (such as cholesteric liquid crystal) may be used.

Also, the type and structure of the linear polarizing plate are not particularly limited. For example, a normal linear polarizing plate used in the field of displays can be used.

The liquid crystal panel of the present invention may be any of transmissive, reflective, and semi-transmissive type. In the case of the transmissive or semi-transmissive type, it is preferable that the liquid crystal panel of the present invention further include a pair of circular polarizing plates or a pair of linear polarizing plates.

A second aspect of the present invention is a liquid crystal display including the liquid crystal panel of the present invention.

### Advantageous Effects of Invention

According to the present invention, a liquid crystal panel that can improve viewing angle characteristics and a liquid crystal display can be realized.

### BRIEF DESCRIPTION OF DRAWINGS

FIG. 1 is a plan schematic diagram showing a liquid crystal display of a first embodiment.

FIG. 2 is a sectional schematic diagram upon application of no voltage taken along line A-B in FIG. 1.

FIG. 3 is a sectional schematic diagram upon application of voltage at line A-B in FIG. 1.

FIG. 4 is a sectional schematic diagram showing the liquid crystal display of the first embodiment.

FIG. 5 is a schematic diagram showing the arrangement relationship of the optical axes in a liquid crystal panel of a first example.

FIG. 6 shows the γ shift of the liquid crystal panel of the first example where P/d=1.62.

FIG. 7 shows the γ shift of the liquid crystal panel of the first example where P/d=1.91.

FIG. 8 shows the γ shift of the liquid crystal panel of the first example where P/d=2.50.

FIG. 9 shows the γ shift of the liquid crystal panel of the first example where P/d=3.12.

FIG. 10 is a graph showing the relationship between P/d and the alignment stability of liquid crystal of the first example and a first comparative example.

FIG. 11 shows a microphotograph of the liquid crystal panel of the first example.

FIG. 12 is a sectional schematic diagram upon application of voltage to the liquid crystal panel of the first example.

FIG. 13 is a plan schematic diagram showing a pixel model used for a simulation.

FIG. 14 is a sectional schematic diagram taken along line C-D in FIG. 13.

FIG. 15 is a schematic diagram showing the arrangement relationship of the optical axes in the simulation according to the first embodiment.

FIG. 16 shows the calculation result of the γ shift of a first sample (P/d=0.66) according to the first embodiment.

FIG. 17 shows the calculation result of the γ shift of a second sample (P/d=0.83) according to the first embodiment.

FIG. 18 shows the calculation result of the γ shift of a third sample (P/d=1.00) according to the first embodiment.

FIG. 19 shows the calculation result of the γ shift of a fourth sample (P/d=2.00) according to the first embodiment.

FIG. 20 is a schematic diagram showing another arrangement relationship of the optical axes in the liquid crystal panel of the first example.

FIG. 21 shows the γ shift of the liquid crystal panel of the first example where P/d=1.62.

FIG. 22 is a schematic diagram showing the arrangement relationship of the optical axes in a liquid crystal panel of a second example.

FIG. 23 shows the γ shift of the liquid crystal panel of the second example where P/d=1.62.

FIG. 24 shows the calculation result of the γ shift of a fifth sample (P/d=0.87) according to the first embodiment.

FIG. 22 is a schematic diagram showing another arrangement relationship of the optical axes in the simulation according to the first embodiment.

FIG. 26 shows the calculation result of the γ shift of a sixth sample (P/d=0.87) according to the first embodiment.

FIG. 27 is a plan schematic diagram showing a liquid crystal display of a second embodiment.

FIG. 28 is a sectional schematic diagram upon application of no voltage taken along line E-F in FIG. 27.

FIG. 29 is a sectional schematic diagram upon application of voltage taken along line E-F in FIG. 27.

FIG. 30 is a plan schematic diagram for describing the alignment state, upon application of voltage, of liquid crystal molecules in the liquid crystal display of the second embodiment.

### DESCRIPTION OF EMBODIMENTS

The present invention will be described in more detail by discussing embodiments hereinafter with reference to the drawings. However, the present invention is not limited only to these embodiments.

In the present specification, a cell thickness d is measured using a cell gap inspection system (RETS series) manufactured by Otsuka Electronics Co., Ltd.

In the following embodiments, the 3 o'clock direction, 12 o'clock direction, 9 o'clock direction, and 6 o'clock direction when a liquid crystal panel is viewed in plane serve as the 0° orientation, 90° orientation, 180° orientation, and 270° orientation, a direction passing 3 o'clock and 9 o'clock serves as a horizontal direction, and a direction passing 12 o'clock and 6 o'clock serves as a vertical direction. Also, viewed in plane means observing from the direction of the normal of a screen of the liquid crystal panel, and the front direction means the direction of the normal of the screen of the liquid crystal panel.

Also, only one picture element (sub pixel) is mainly shown in the following drawings. However, a plurality of pixels are provided in a matrix in a display region (region displaying an image) of a liquid crystal display of each of the embodiments. Each pixel includes a plurality of (normally three) picture elements.

### First Embodiment

A liquid crystal display of the present embodiment is a transmissive-type liquid crystal display in a TBA (Transverse Bend Alignment) mode. The TBA mode is one type of horizontal electric field system. The horizontal electric field system performs image display by generating a horizontal electric field in a liquid crystal layer and controlling the alignment of liquid crystal molecules.

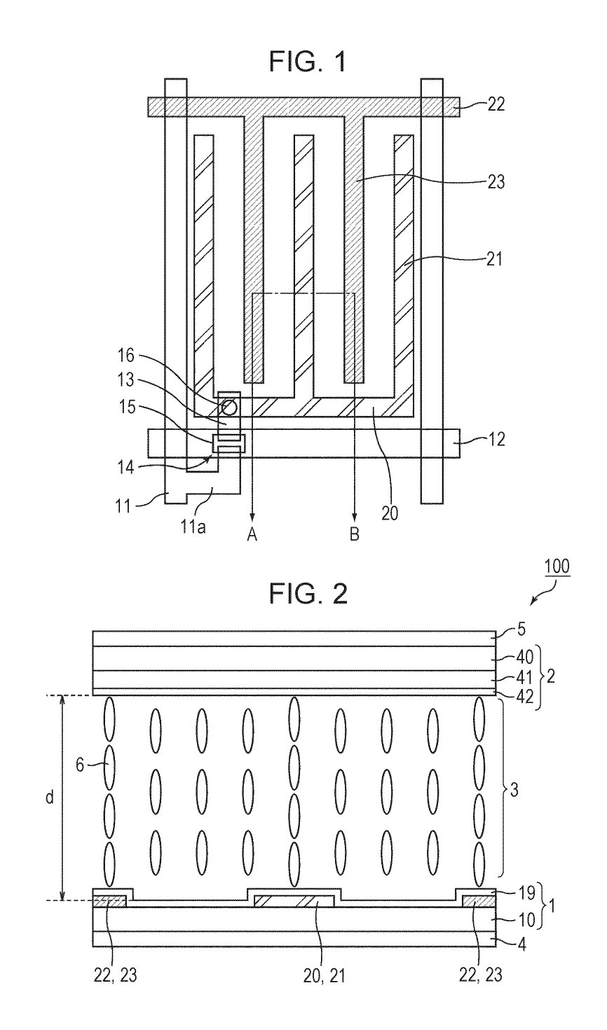

As shown in FIG. 2, the liquid crystal display of the present embodiment includes a liquid crystal panel 100, a backlight unit (not shown) provided behind the liquid crystal panel 100, and a controller (not shown) that drives and controls the liquid crystal panel 100 and the backlight unit.

The liquid crystal panel 100 includes an active matrix substrate (TFT array substrate) 1 (hereinafter may simply be referred to as a substrate 1) corresponding to the above-described first substrate, an opposing substrate 2 (hereinafter may simply be referred to as a substrate 2) that corresponds to the above-described second substrate and that faces the substrate 1, a liquid crystal layer 3 sandwiched between these substrates, and a pair of polarizing plates 4 and 5 provided on the opposite side from the liquid crystal layer 3 of the substrates 1 and 2. The substrate 1 is provided on the back side of the liquid crystal display. The substrate 2 is provided on the observer side. The polarizing plates 4 and 5 are arranged in cross-Nicol.

The substrates 1 and 2 are attached with a sealing member (not shown) provided to surround the display region. Also, the substrates 1 and 2 face each other via a spacer (not shown) such as a column-shaped spacer or the like. By filling the gap between the substrates 1 and 2 with a liquid crystal material, the liquid crystal layer 3 is formed as an optical modulation layer.

The active matrix substrate 1 includes a colorless transparent insulating substrate 10 formed of a material such as glass, plastic, or the like. As shown in FIGS. 1 and 2, on the main face on the liquid crystal layer 3 side of the insulating substrate 10, a plurality of gate bus lines 12 parallel to one another (hereinafter may simply be referred to as bus lines 12), a plurality of source bus lines 11 (hereinafter may simply be referred to as bus lines 11) orthogonal to the gate bus lines 12, thin-film transistors (TFTs) 14 that are switching elements and that are provided on the individual picture elements, pixel electrodes 20 (hereinafter may simply be referred to as electrodes 20) that correspond to the above-described first electrode and that are provided on the individual picture elements, a plurality of opposing electrodes 22 corresponding to the above-described second electrode, and a vertical alignment film 19 are formed. A region defined by the bus lines 11 and 12 roughly serves as one picture element region. The opposing electrodes 22 are provided in common to, among a plurality of picture elements, picture elements adjacent to one another in a direction in which the gate bus lines 12 extend (hereinafter may also be referred to as horizontal picture elements). An image signal (voltage) is applied to the pixel electrodes 20. The opposing electrodes 22 are electrodes (common electrodes) for applying a common voltage to all the picture elements. The opposing electrodes 22 are connected to one another outside the display region. A voltage common to all the picture elements (common voltage) is applied to the opposing electrodes 22.

The TFTs 14 each include a gate electrode that functions as a gate and that is part of a gate bus line 12, a source electrode 11a that functions as a source and that is connected to a source bus line 11, and a drain electrode 13 that functions as a drain. The TFTs 14 are each provided near the intersection of the bus lines 11 and 12, and each include a semiconductor layer 15 formed as an island shape on the gate bus line 12.

The source bus lines 11 are connected to a source driver (not shown) outside the display region. The gate bus lines 12 are connected to a gate driver (not shown) outside the display region. The gate bus lines 12 also function as gate electrodes of the TFTs 14 in the display region. Also, a scanning signal is supplied as a pulse from the gate driver to the gate bus lines 12 at a certain timing. The scanning signal is line sequentially applied to the TFTs 14.

The pixel electrodes 20 and the opposing electrodes 22 are pairs of comb electrodes. The pixel electrodes 20 each include a plurality of line-shaped portions 21 corresponding to teeth and a line-shaped portion (a shaft portion) connecting the line-shaped portions 21. The opposing electrodes 22 each include a plurality of line-shaped portions 23 corresponding to teeth and a line-shaped portion (a shaft portion) connecting the line-shaped portions 23. The pixel electrodes 20 and the opposing electrodes 23 are arranged so that the line-shaped portions 21 and 23 thereof engage with each other at a gap (interval). The line-shaped portions 21 and 23 are alternately arranged and are parallel to each other. The line-shaped portions 21 and 23 are straight line portions extending in the vertical direction in FIG. 1. However, as long as the pixel electrodes 20 and the opposing electrodes 22 can generate a desired electric field, the shapes of the line-shaped portions 21 and 23 may be other shapes (such as V shape, broken line shape, or curve shape).

When attention is paid to the sectional structure of the substrate 1, a first wiring layer, a gate insulating film (not shown) covering the first wiring layer, the semiconductor layer 15, a second wiring layer, an insulating layer (not shown) covering the second wiring layer, an electrode layer, and the vertical alignment film 19 are stacked in this order on the insulating substrate 10. The gate bus lines 12 are formed on the first wiring layer. The source bus lines 11, the source electrodes 11a, and the drain electrodes 13 are formed on the second wiring layer. The pixel electrodes 20 and the opposing electrodes 22 are formed on the electrode layer. In this manner, the pixel electrodes 20 and the opposing electrodes 22 are formed on the same insulating layer. The pixel electrodes 20 are electrically connected to the drain electrodes 13 of the TFTs 14 via contact holes 16 penetrating through the insulating layer.

The opposing substrate 2 includes a colorless transparent insulating substrate 40 formed of a material such as glass, plastic, or the like. A color filter layer 41 and a vertical alignment film 42 are stacked in this order on the main face on the liquid crystal layer 3 side of the insulating substrate 40.

The liquid crystal layer 3 includes nematic liquid crystal molecules 6 whose dielectric constant anisotropy is positive. Due to the anchoring force of the vertical alignment films 19 and 42, the liquid crystal molecules 6 exhibit homeotropic alignment upon application of no voltage (when no electric field is generated by the above-described electrodes 20 and 22), and the liquid crystal molecules 6 are aligned approximately in the vertical direction with respect to the main faces of the substrates 1 and 2. A pre-tilt angle of the liquid crystal layer 3 is greater than or equal to 86° (preferably greater than or equal to 88°) and less than or equal to 90°. When the pre-tilt angle is less than 86°, contrast may be reduced.

Since the liquid crystal panel 100 includes the pair of polarizing plates 4 and 5 arranged in cross-Nicol and includes the vertical alignment liquid crystal layer 3, the liquid crystal panel 100 is in a normally black mode.

The TFTs 14 are turned on only in a certain period in response to input of a scanning signal. While the TFTs 14 are turned on, the source bus lines 11 supply an image signal to the pixel electrodes 20 at a certain timing. That is, a voltage in accordance with the image signal is applied to the pixel electrodes 20.

In contrast, a certain voltage (AC voltage or DC voltage, such as 0 V) is applied to the opposing electrodes 22.

Upon application of an image signal (voltage) to the pixel electrodes 20 (hereinafter may also be referred to as upon application of voltage), an electric field is generated between the pixel electrodes 20 and the opposing electrodes 22, which is directed from the pixel electrodes 20 to the opposing electrodes 22. This electric field is an electric field (arch-shaped horizontal electric field) approximately parallel to the main faces of the substrates 1 and 2. Due to this horizontal electric field, the liquid crystal molecules 6 exhibit bend alignment. Thus, the retardation of the liquid crystal layer 3 changes, and the transmittance of each picture element changes. As a result, an image is displayed.

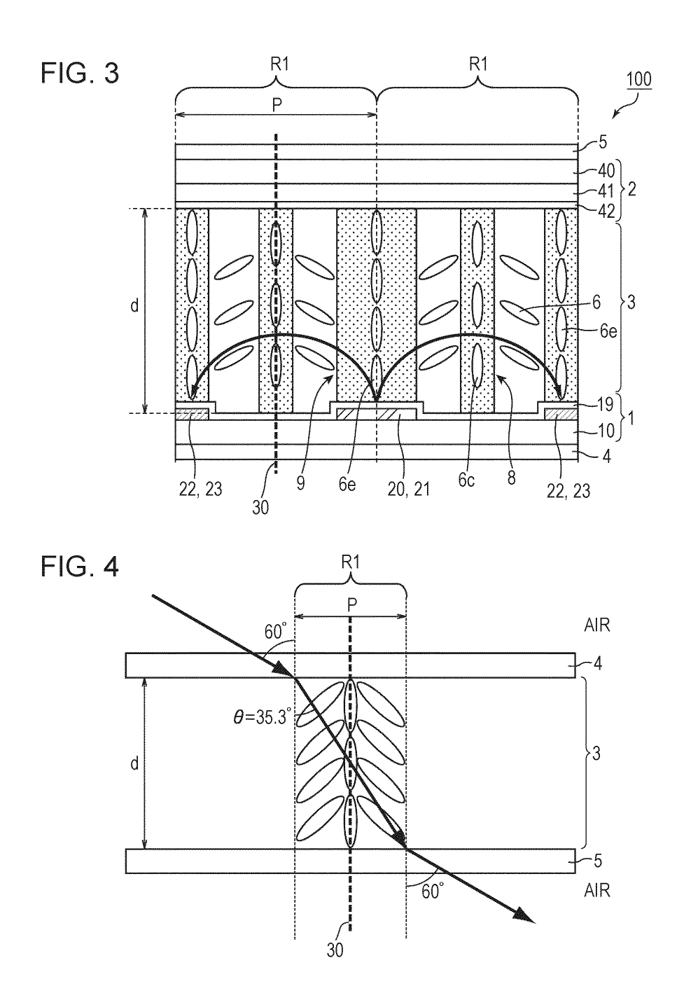

Hereinafter, the alignment state of the liquid crystal molecules 6 upon application of voltage will be described in detail. As shown in FIG. 3, when a voltage is applied to the pixel electrodes 20, since the dielectric constant anisotropy of the liquid crystal molecules 6 is positive, the liquid crystal molecules 6 exhibit bend alignment along the electric line of force of the horizontal electric field.

Note that liquid crystal molecules 6c near the center between the pixel electrodes 20 and the opposing electrodes 22 are always vertically aligned, regardless of the magnitude of voltage applied to the pixel electrodes 20. This is because other liquid crystal molecules from both sides, more specifically, from the pixel electrodes 20 and the opposing electrodes 22, fall down. Thus, dark lines 8 are always generated in regions where the liquid crystal molecules 6c exist, regardless of the magnitude of voltage applied to the pixel electrodes 20.

Also, because liquid crystal molecules 6e on the line-shaped portions 21 and 23 are hardly affected by the horizontal electric field, the liquid crystal molecules 6e are always vertically aligned, regardless of the magnitude of voltage applied to the pixel electrodes 20. Therefore, dark lines 9 are always generated on the line-shaped portions 21 and 23, regardless of the magnitude of voltage applied to the pixel electrodes 20.

As a result, upon application of voltage, a regular alignment distribution is generated in a region R1 that is a region between the center lines of the line-shaped portions 21 and 23. Also, the liquid crystal molecules 6 with a tilt angle of 0 to 90° exist in the region R1. In the region R1, the liquid crystal molecules 6 are symmetrically aligned with respect to a center line 30 passing the center between the line-shaped portions 21 and 23 (actually a face (virtual face), which extends in a direction parallel to the line-shaped portions 21 and 13). That is, two domains are generated in the region R1.

In the region R1 where the liquid crystal molecules 6 are symmetrically aligned, complementary alignment compensation (self compensation) can be achieved. Hereinafter, the principle thereof will be described using FIG. 4.

In FIG. 4, a light beam entering the liquid crystal panel 100 from a direction at a polar angle of 60° will be described. The reasons a polar angle of 60° is selected are as described in (1) to (4) below. (1) In general, the viewing angle characteristics are worst in a direction at a polar angle of 60°. (2) In general, a liquid crystal display is more likely to be observed within a range from a polar angle of 0° to a polar angle of 60°. (3) Because a light beam entering a liquid crystal panel from a direction exceeding a polar angle of 60° is entirely reflected at the surface of the liquid crystal panel, display characteristics are hardly affected. (4) In consideration of (2) described above, the output light distribution of backlight is normally adjusted so that the proportion of a luminous flux amount within the range from a polar angle of 0° to a polar angle of 60° with respect to the entire emitted light amount exceeds 90%.

In FIG. 4, it is assumed that there is backlight at an upper side. Also, the description assumes the case in which the refractive index of an air layer is 1 and the refractive index of the polarizing plates 4 and 5 is 1.5.

A light beam (indicated by arrows in FIG. 4) entering the liquid crystal panel 100 from a direction at a polar angle of 60° is refracted at the surface of the polarizing plate 4 and enters the liquid crystal layer 3. The refraction angle at this time is about 35.3°) (35.26°. The light beam entering the liquid crystal layer 3 is refracted at the surface of the polarizing plate 5 when exiting to the air layer. The refraction angle at this time is the same angle as the incident angle when the light beam enters the polarizing plate 4. That is, the light beam entering the liquid crystal panel 100 from a direction at a polar angle of 60° finally exits to the air layer at a polar angle of 60°.

In order that this light beam will not disturb the complementary alignment compensation of the liquid crystal molecules 6, the light beam should simply pass through the interior of the region R1. More specifically, upon application of voltage, there are liquid crystal molecules that are symmetrically aligned with respect to the center line 30 (actually the face (virtual face)) in the region R1. Thus, if the above-described light beam could pass through the interior of the region R1, a phase difference generated in the light beam would become substantially the same as a phase difference generated in light entering the region R1 from the front direction. Therefore, the transmittance in the direction at a polar angle of 60° can be made closer to the transmittance in the front direction.

Also, even when the cell thickness d increases, a path of the above-described light beam maintains a similar figure. Therefore, when the cell thickness d increases, the pitch P of the region R1 may be great.

In order to achieve the complementary alignment compensation as described above, the relationship between the pitch P of the region R1, that is, the pitch P between the center lines of the line-shaped portions 21 and 23, and the cell thickness d is important. The smaller the ratio P/d of the pitch P and the cell thickness d becomes, the more improvement in the diagonal viewing angle can be achieved.

As a known liquid crystal display in the TBA mode, for example, a display with L/S=2.5 μm/7.5 μm, and P/d=3 has been put to practical use. This display leaves room for improvement of viewing angle characteristics such as γ shift.

In contrast, P/d<3 is set in the present embodiment. Therefore, the viewing angle characteristics can be improved than before.

For example, if P/d<tan 35.26≈0.7 (preferably 0.7) is satisfied, light entering the liquid crystal panel 100 from a direction at a polar angle of 60° can pass through the interior of the region R1. Thus, the complementary alignment compensation is not disturbed in principle, and the transmittance does not change between the front direction and the diagonal direction. In other words, if P/d<tan 35.26≈0.7 (preferably 0.7) is satisfied, light entering the liquid crystal panel 100 from a direction at a polar angle of 0° to a polar angle of 60° can be mutually and completely compensated for by two domains in the region R1, and the γ shift can be particularly improved.

Hereinafter, the liquid crystal panel 100 and each member will be further described.

It is preferable that the widths of the line-shaped portions 21 and 23 be as thin as possible. From the viewpoint of preventing the occurrence of defects such as broken wires, it is preferable that the widths of the line-shaped portions 21 and 23 be 3 μm (more preferably 2 μm) or greater. The widths of the line-shaped portions 21 and 23 may be different from each other.

In the present specification, the width of a line-shaped portion means the length of the line-shaped portion in a direction orthogonal to the longitudinal direction.

The cell thickness d is about 2.8 to 5 μm (preferably 3 to 4 μm). It is preferable that the product (panel retardation) of the cell thickness d and the refractive index anisotropy Δn (value corresponding to light with wavelength λ) of the liquid crystal material satisfy approximately λ/2. Specifically, it is preferable that 280≦dΔn≦450 nm be satisfied, and it is more preferable that 280≦dΔn≦340 nm be satisfied.

As the backlight unit and the controller, ones as known in the art may be appropriately used.

As the circular polarizing plates 4 and 5, a pair of circular polarizing plates or a pair of linear polarizing plates can be used. A circular polarizing plate is an optical element that passes through one of right-handed circularly polarized light and left-handed circularly polarized light and absorbs or reflects the other.

When a pair of circular polarizing plates are used as the circular polarizing plates 4 an 5, the pair of circular polarizing plates are arranged in cross-Nicol. One circular polarizing plate includes a first λ/4 plate (not shown) and a first linear polarizing plate (not shown) stacked in this order from the substrate 1 side. An angle defined by the optical axis (slow axis) of the first λ/4 plate and the absorption axis of the first linear polarizing plate is set to approximately 45°. The other circular polarizing plate includes a second λ/4 plate (not shown) and a second linear polarizing plate (not shown) stacked in this order from the substrate 2 side. An angle defined by the optical axis (slow axis) of the second λ/4 plate and the absorption axis of the second linear polarizing plate is set to approximately 45°. The optical axes (slow axes) of the first and second λ/4 plates are approximately orthogonal to each other. The absorption axes of the first and second linear polarizing plates are approximately orthogonal to each other.

When a pair of linear polarizing plates are used as the circular polarizing plates 4 and 5, the pair of linear polarizing plates are arranged in cross-Nicol. That is, the absorption axes of the pair of linear polarizing plates are approximately orthogonal to each other. The absorption axes of the pair of linear polarizing plates are set to an orientation of approximately 45° and to an orientation of approximately 135°.

Each linear polarizing plate includes a linear polarizing element. A linear polarizing element is typically one in which an anisotropic material such as an iodic complex with dichroism is absorbed and aligned on a polyvinyl alcohol (PVA) film. To ensure the mechanical strength and humidity and heat resistance, generally each linear polarizing plate further includes a protection film such as a triacetyl cellulose (TAC) film laminated on both sides of the PVA film via adhesion layers.

In order to further improve the viewing angle characteristics, an optical film such as a phase difference plate may be provided between at least one of the substrate 1 and the polarizing plate 4 and between the substrate 2 and the polarizing plate 5.

The vertical alignment films 19 and 42 are formed without any gap, at least covering the entire display region. The vertical alignment films 19 and 42 can align nearby liquid crystal molecules 6 substantially in the vertical direction with respect to the film surface. The material of the vertical alignment films 19 and 42 is not particularly limited. For example, an alignment film material used in a known VA mode or an optical alignment film material used in a vertical alignment twisted nematic (VATN) mode may be used. The vertical alignment films 19 and 42 may be organic alignment films formed using an organic material such as polyimide or may be inorganic alignment films formed using an inorganic material such as silicon oxide.

A method of forming the vertical alignment films 19 and 42 using an optical alignment film material may be, for example, a method of irradiating, from the vertical direction, an optical alignment film with ultraviolet light and developing a pre-tilt angle of approximately 90°. As described above, although the vertical alignment films 19 and 42 may have been subjected to alignment processing such as rubbing or ultraviolet light irradiation, it is preferable that the vertical alignment films 19 and 42 have not been subjected to alignment processing. It is preferable to develop vertical alignment only by forming a film. Accordingly, an alignment processing step may be omitted, and manufacturing steps may be simplified.

As the material of the pixel electrodes 20 and the opposing electrodes 22, a translucent conductive material is preferable. Among such materials, metal oxide such as indium tin oxide (ITO) or indium zinc oxide (IZO) is preferably used.

As the materials of members provided on the substrate 1 (such as the bus lines 11 and 12 and the semiconductor layer 15) other than those described above, materials as known in the art may be used.

The color filter layer 41 includes a plurality of color layers (color filters) provided corresponding to the individual picture elements. The color layers are used to perform color display. The color layers are formed of a transparent organic insulating film such as acrylic resin containing pigments and are mainly formed in picture element regions. Accordingly, color display can be performed. Each pixel includes, for example, three picture elements outputting R (red), G (green), and B (blue) light. The types and number of colors of the picture elements included in each pixel are not particularly limited and may appropriately be set. That is, each pixel may include, for example, three picture elements of cyan, magenta, and yellow, or each pixel may include picture elements of four or more colors (such as R, G, B, and Y (yellow)).

The color filter layer 41 may further include a black matrix (BM) layer that blocks light between the picture elements. The BM layer can be formed from an opaque metal film (such as a chromium film) and/or an opaque organic film (such as acrylic resin containing carbon). The BM layer is formed in a region corresponding to a boundary region between adjacent picture elements.

An overcoat layer may be provided between the color filter layer 41 and the vertical alignment film 42. Accordingly, the surface of the substrate 2, facing the liquid crystal layer 3, can be made planar. A protrusion may be provided on the surface of the overcoat layer, and this protrusion may function as a column-shaped spacer. A method of forming a protrusion on the overcoat layer may be photolithography using a multi-gradation-level photo mask.

### First Example and First Comparative Example

A plurality of liquid crystal panels according to the first embodiment were actually manufactured.

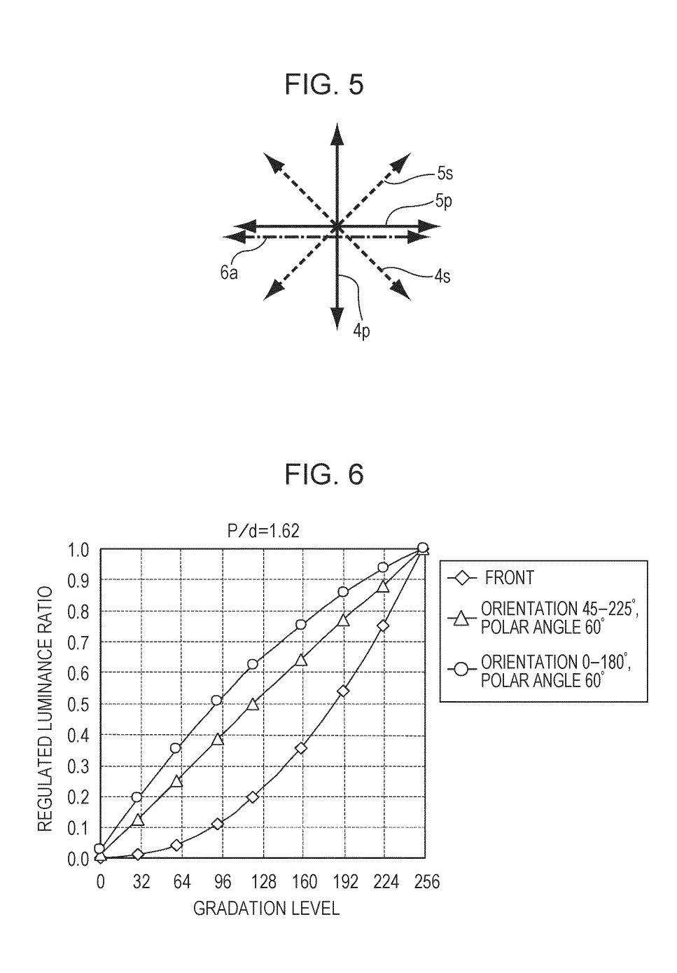

Glass substrates were used as the insulating substrates 10 and 40. The pixel electrodes 20 and the opposing electrodes 22 were formed by patterning, using photolithography, an ITO film (thickness 140 nm) formed by performing sputtering on the entire insulating substrate 10. An overcoat layer was not formed on the insulating substrate 40. The space between the insulating substrates 10 and 40 was filled with a positive-type liquid crystal material (Δ∈=8) manufactured by Merck by using a vacuum impregnation method. As the polarizing plates 4 and 5, circular polarizing plates were used, in each of which a λ/4 plate and a linear polarizing plate were stacked in this order from the insulating substrates 10 and 40 side. As shown in FIG. 5, in the polarizing plate 4, the absorption axis 4p of the linear polarizing plate and the in-plane slow axis 4s of the λ/4 plate were set to an orientation of 90° and an orientation of 135°, respectively. In the polarizing plate 5, the absorption axis 5p of the linear polarizing plate and the in-plane slow axis 5s of the λ/4 plate were set to an orientation of 0° and an orientation of 45°, respectively. The domain axis 6a of the liquid crystal molecules 6 was set to an orientation of 0°. Note that the domain axis indicates the alignment orientation (tilt orientation) of liquid crystal molecules upon application of voltage. Therefore, the domain axis 6a is orthogonal to the line-shaped portions 21 and 23.

In the individual panels, the width L of teeth (line-shaped portions 21 and 23), the spacing S between teeth, the pitch P of the region R1, the cell thickness d, and the refractive index anisotropy Δn of the liquid crystal material were set as indicated in Table 1 below. In the individual panels, the retardation (Re=Δn·d) of the liquid crystal layer 3 was adjusted so as to be approximately constant. Panels with P/d=3.12 or 3.68 correspond to a first comparative example, and the other panels correspond to a first example. Since the panels have the single width L and the single spacing S, the pitch P, the width L, and the width S satisfy the relationship P=L+S.

TABLE 1

| | | | Δnd | | |
|---|---|---|---|---|---|
| | | | 313 | 312 | 319 |
| | | | Δn | | |
| | | | 0.09 | 0.07 | 0.07 |
| | | | d (μm) | | |
| | | | 3.4 | 4.4 | 4.9 |
| L (μm) | S (μm) | P (μm) | P/d | | |
| 2.8 | 2.7 | 5.5 | 1.62 | 1.25 | 1.12 |
| 3.3 | 3.3 | 6.6 | 1.94 | 1.50 | 1.35 |
| 3.7 | 4.8 | 8.5 | 2.50 | 1.93 | 1.73 |
| 3.8 | 6.8 | 10.6 | 3.12 | 2.41 | 2.16 |
| 3.4 | 9.1 | 12.5 | 3.68 | 2.84 | 2.55 |

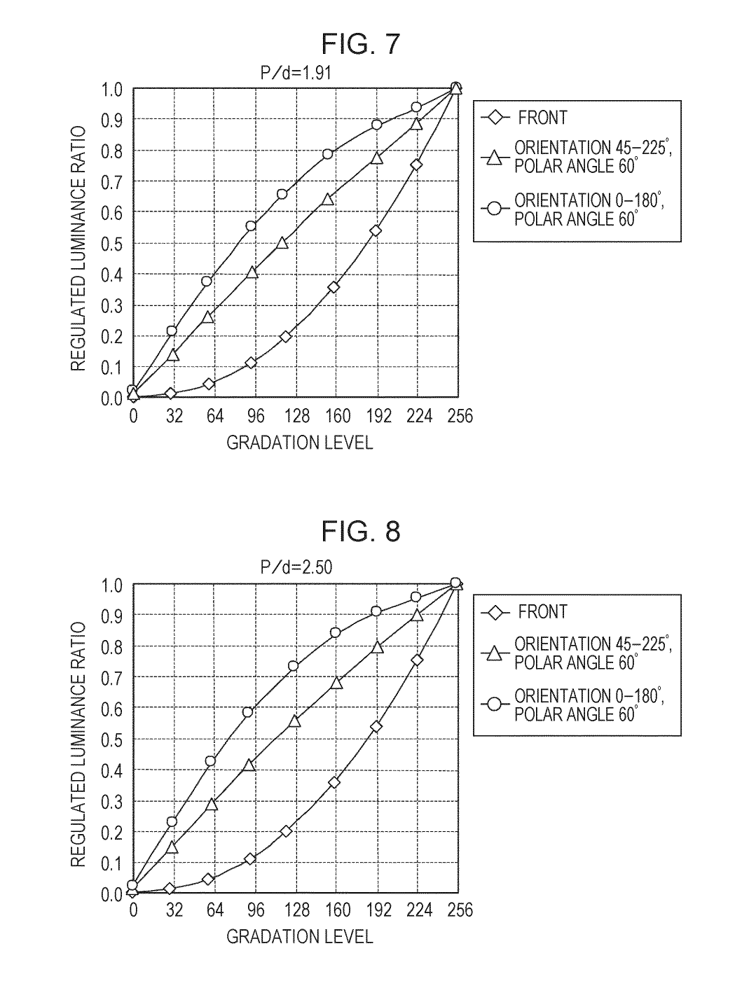

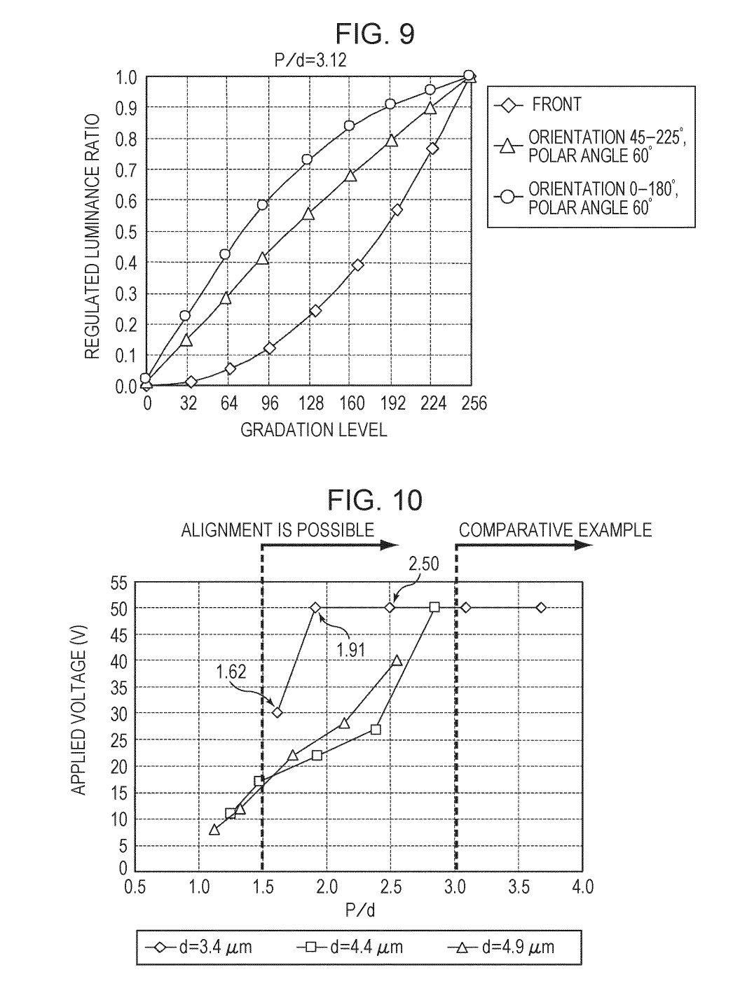

Compared with the panels of the first comparative example, in the first example, the tendency that reduction of P/d improves the γ shift was noted. Specifically, FIGS. 6 to 9 show the measurement results of the γ shift of the liquid crystal panels of the first example and the first comparative example. FIG. 6 shows the γ shift of the liquid crystal panel of the first example where P/d=1.62. FIG. 7 shows the γ shift of the liquid crystal panel of the first example where P/d=1.91. FIG. 8 shows the γ shift of the liquid crystal panel of the first example where P/d=2.50. FIG. 9 shows the γ shift of the liquid crystal panel of the first comparative example where P/d=3.12. The γ shift indicates how much the γ curve in the diagonal direction changes with respect to the γ shift in the front direction.

In FIGS. 6 to 9, gradation levels are plotted in abscissa, and regulated luminance ratios are plotted in ordinate. A regulated luminance ratio indicates the ratio of luminance of each gradation level to the luminance of the highest gradation level (255 gradation level). Each plot in FIGS. 6 to 9 is corrected at γ=2.2. Further, FIGS. 6 to 9 show the results in the front direction, the direction in which the orientation is 45° or 225° and the polar angle is 60°, and the direction in which the orientation is 0° or 180° and the polar angle is 60°. As shown in FIGS. 6 to 9, it was made clear that reduction of P/d improves the γ shift.

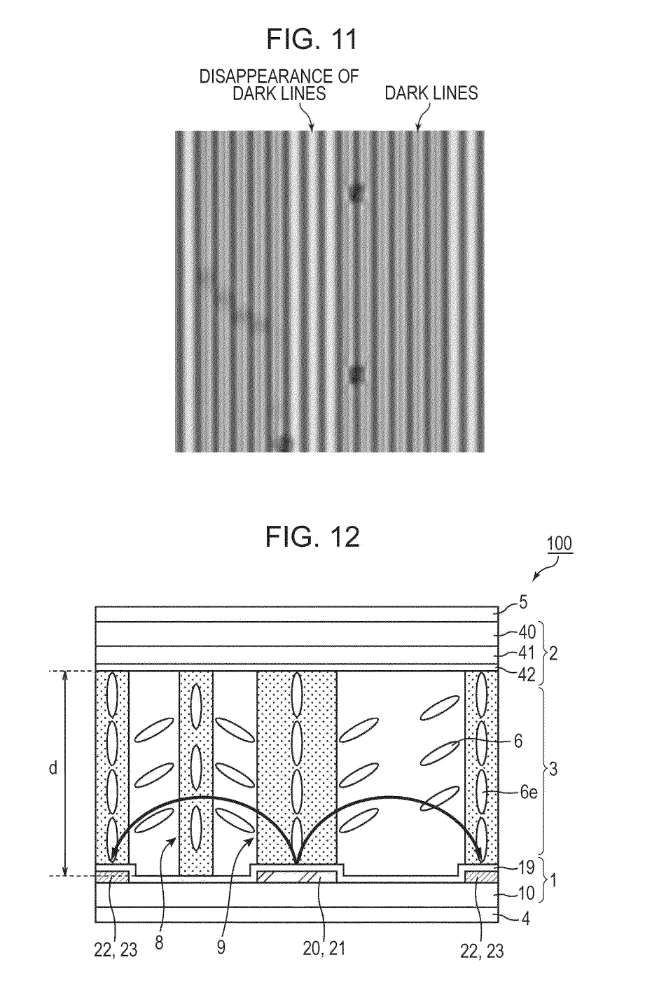

Next, for each panel, the result of investigating the relationship between P/d and the alignment stability of liquid crystal is shown. FIG. 10 is a graph showing the relationship between P/d and the alignment stability of liquid crystal of the first example and the first comparative example. As shown in FIGS. 11 and 12, an applied voltage when the liquid crystal alignment is disturbed is plotted in ordinate of FIG. 10. At this time, as shown on the right of FIG. 12, it is considered that the liquid crystal molecules 6 are aligned not symmetrically between the electrodes 20 and 22, but are aligned unequally toward one of the electrodes. Therefore, as shown in FIG. 11, it is considered that the dark lines 8 necessary for symmetrical liquid crystal alignment have disappeared.

When the pitch P is small and/or when the cell thickness id is great, the liquid crystal alignment is disturbed if the applied voltage increases. That is, although an alignment state in which the dark lines 8 are generated is an alignment state necessary for the present embodiment, the symmetry of the liquid crystal molecules 6 is lost in a portion where the dark lines 8 have disappeared. In the example where P/d≦1.5, a voltage of the 255 gradation level could not be applied, and the γ shift could not be evaluated.

Therefore, from the viewpoint of stably achieving a desired alignment state in the present embodiment, it is preferable to set 1.5<P/d. Also, from the viewpoint of stably achieving a desired alignment state and improving the γ shift, it is preferable to set 1.5<P/d<3.0.

Therefore, because the alignment direction of the liquid crystal molecules 6 can be fixed by forming alignment auxiliary layers on the vertical alignment films 19 and 42, even if P/d is less than 1.5, a desired alignment state can be stably achieved.

The alignment auxiliary layers can be formed using the alignment sustained technology using polymer, that is, the so-called PSA (Polymer Sustained Alignment) technology. Specifically, the space between the substrates 1 and 2 is filled with a composition including a mixture of a liquid crystal material and a polymerizable component such as monomer or oligomer. While a certain voltage is being applied to each electrode, the composition is heated and/or irradiated with light (such as ultra violet light), thereby polymerizing the polymerizable component. Accordingly, an alignment auxiliary layer including polymer can be formed. Even upon application of no voltage, the liquid crystal molecules 6 have a certain pre-tilt angle, and the alignment orientation of the liquid crystal molecules 6 is defined. Note that polymerization of the polymerizable component may be performed while no voltage is being applied.

As described above, the γ shift could not be evaluated in the example where P/d≦1.5. Therefore, the inventors of the present invention conducted a simulation of a pixel model according to the first embodiment in order to further confirm the advantageous effects of the present embodiment. In the simulation, PRIME-3D manufactured by Shintec was used.

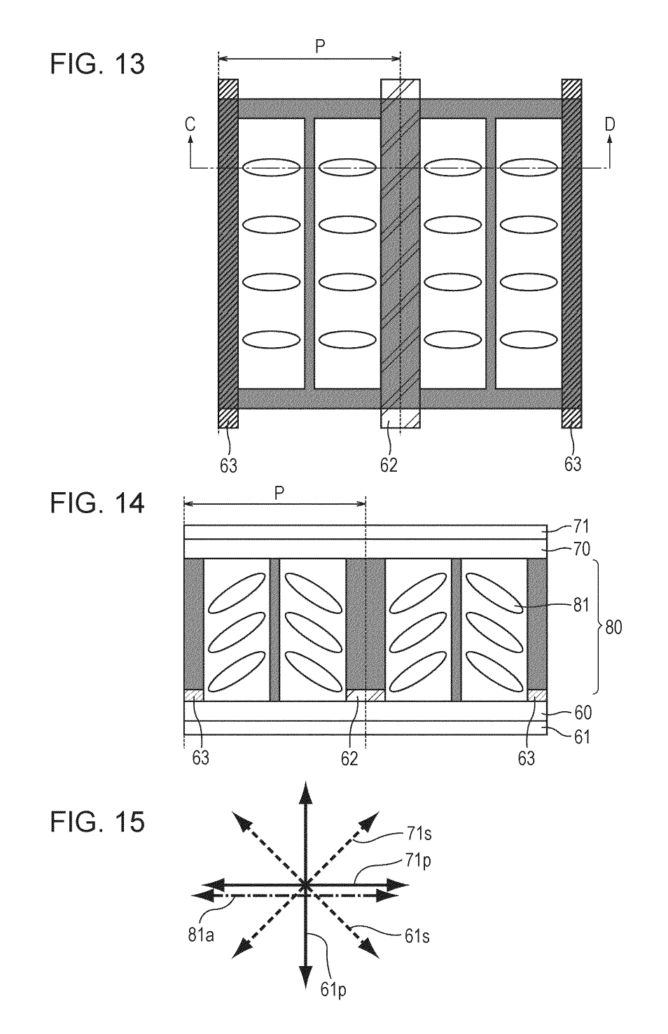

The pixel model for the simulation includes a configuration of some of the picture elements shown in FIG. 1. Specifically, as shown in FIGS. 13 and 14, the pixel model included a pair of substrates 60 and 70, a liquid crystal layer 80 sandwiched between the substrates 60 and 70, a pair of circular polarizing plates 61 and 71 provided on the outer side of the pair of substrates, and pixel electrodes 62 and opposing electrodes 63 formed on the substrate 60. The pixel electrodes 62 and the opposing electrodes 63 each included only line-shaped portions. The liquid crystal layer 80 was a vertical alignment liquid crystal layer and included liquid crystal molecules 81 whose dielectric constant anisotropy was positive. The circular polarizing plates 61 and 71 each included a λ/4 plate and a linear polarizing plate stacked in this order from the substrates 60 and 70 side. As shown in FIG. 15, in the circular polarizing plate 61, the absorption axis 61p of the linear polarizing plate and the in-plane slow axis 61s of the λ/4 plate were set to an orientation of 90° and an orientation of 135°, respectively. In the circular polarizing plate 71, the absorption axis 71p of the linear polarizing plate and the in-plane slow axis 71s of the plate were set to an orientation of 0° and an orientation of 45°, respectively. A domain axis 81a was set to an orientation of 0°. Therefore, the domain axis 81a is orthogonal to the line-shaped portions of the pixel electrodes 62 and the opposing electrodes 63. The cell thickness d was fixed to 3.00 μm.

Calculations were performed for four samples (first to fourth samples) where P/d was set to 0.66, 0.83, 1.00, or 2.00.

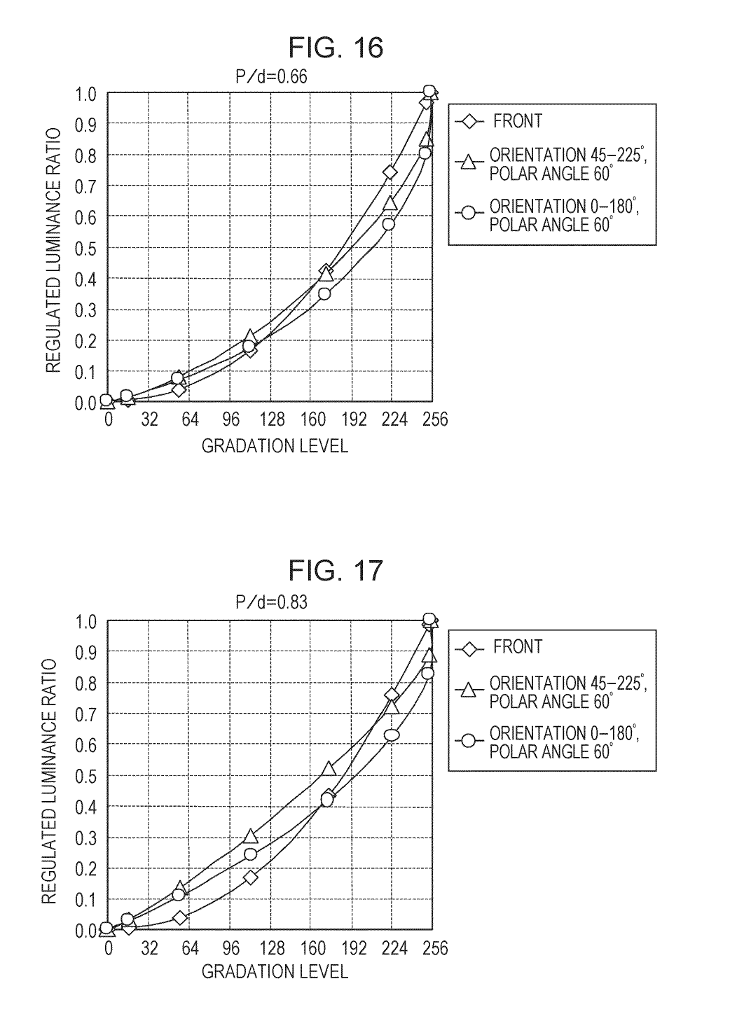

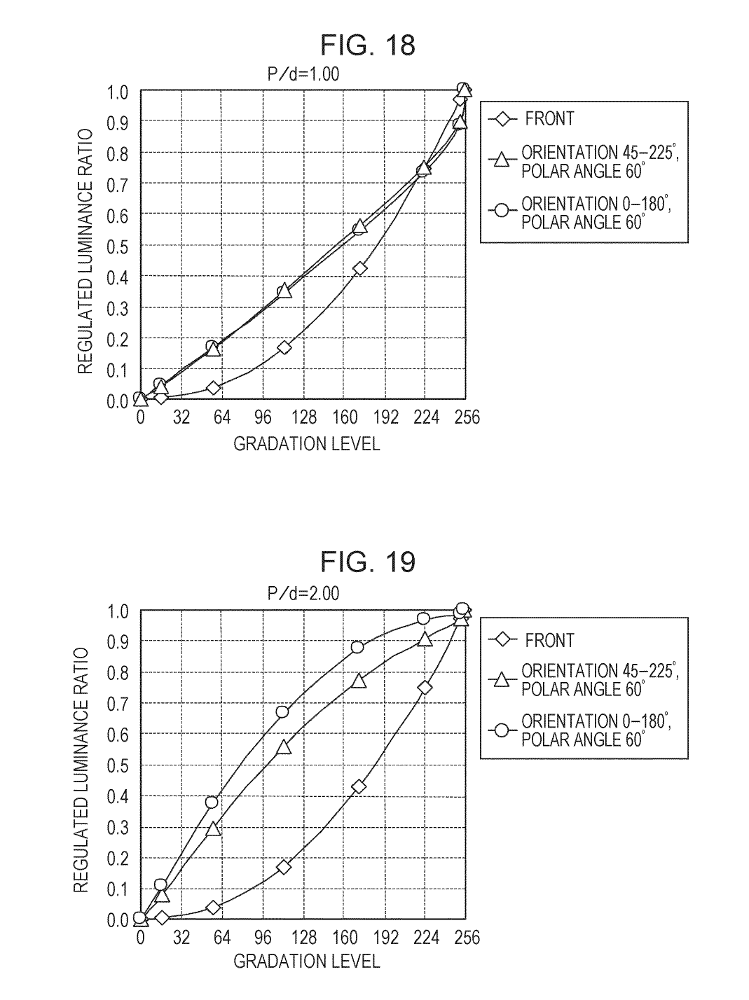

FIGS. 16 to 19 show the results. FIGS. 16, 17, 18, and 19 are the calculation results of the γ shift of the first sample (P/d=0.66), the second sample (P/d=0.83), the third sample (P/d=1.00), and the fourth sample (P/d=2.00) according to the first embodiment. When P/d=0.83 or less, it was confirmed that the γ curve in the direction at a polar angle of 60° scarcely deviates from the γ curve in the front direction, which is the result as the above-described theory.

Next, the result of investigating how the types of polarizing plates affect the viewing angle characteristics (γ shift) will be described.

In the liquid crystal panel of the first example where P/d=1.62, as shown in FIG. 5, the domain axis 6a was along the absorption axis 5p, and the γ shift thereof was as shown in FIG. 6.

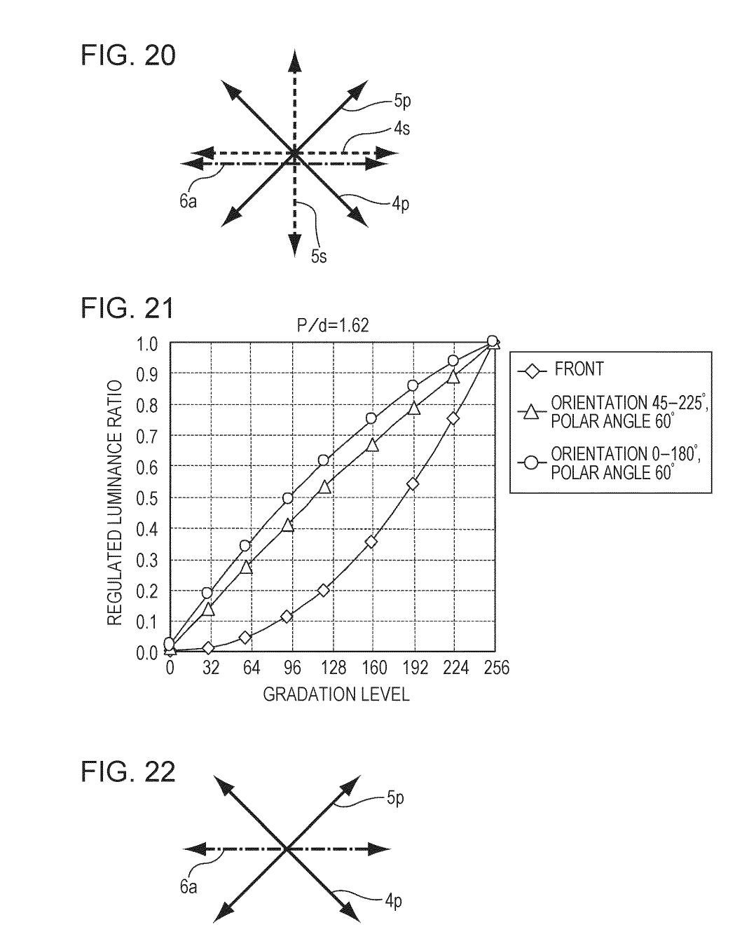

Here, the optical axis of the panel was rotated only by 45°, as shown in FIG. 20, and the γ shift was measured. Specifically, in the polarizing plate 4, the absorption axis 4p of the linear polarizing plate and the in-plane slow axis 4s of the λ/4 plate were set to an orientation of 135° and an orientation of 180°, respectively. In the polarizing plate 5, the absorption axis 5p of the linear polarizing plate and the in-plane slow axis 5s of the λ/4 plate were set to an orientation of 45° and an orientation of 90°, respectively. The domain axis 6a remains as an orientation of 0°.

FIG. 21 shows the result. When FIGS. 6 and 21 are compared with each other, it was made clear that, in the liquid crystal panel of the first example where P/d=1.62, the orientations of the axes of the polarizing plates scarcely affect the γ shift.

### Second Example

Excluding the fact that, instead of circular polarizing plates, linear polarizing plates were used as the polarizing plates 4 and 5, a liquid crystal panel of a second example where P/d=1.62 was manufactured in the same manner as in the first example.

As shown in FIG. 22, the absorption axis 4p of the polarizing plate 4 (linear polarizing plate) was set to an orientation of 135°. The absorption axis 5p of the polarizing plate 5 (linear polarizing plate) was set to an orientation of 45°. The domain axis 6a remains as an orientation of 0°.

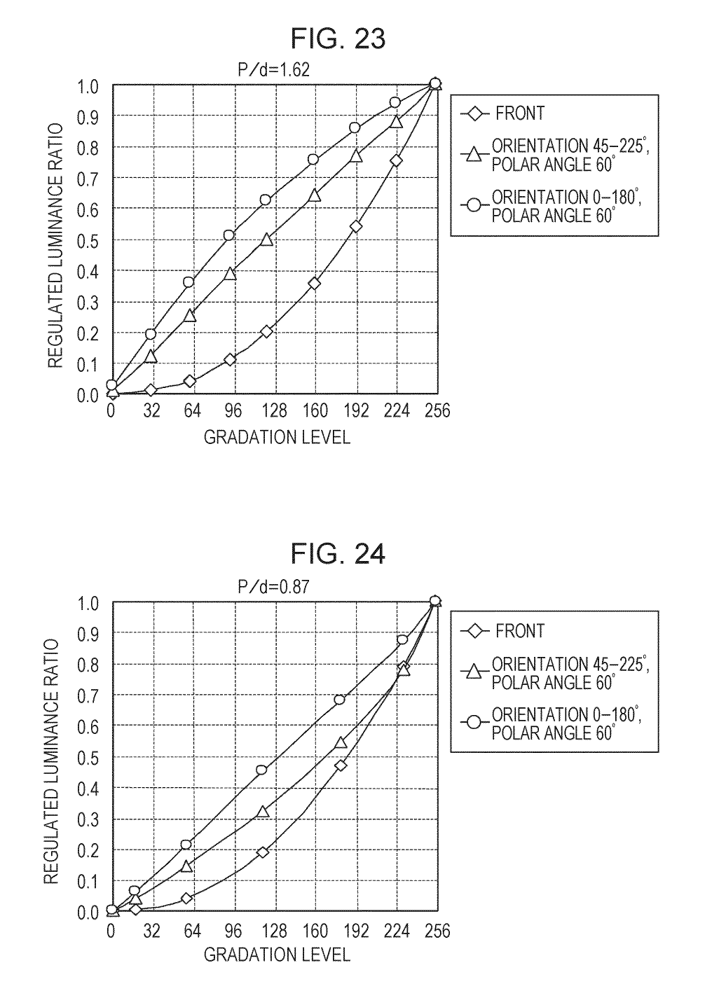

FIG. 23 shows the result. When FIGS. 6, 21, and 23 are compared with one another, the γ shifts of the liquid crystal panels where P/d=1.6 are equivalent, and it was made clear that the orientations of the axes of the polarizing plates and the types of polarizing plate scarcely affect the γ shift.

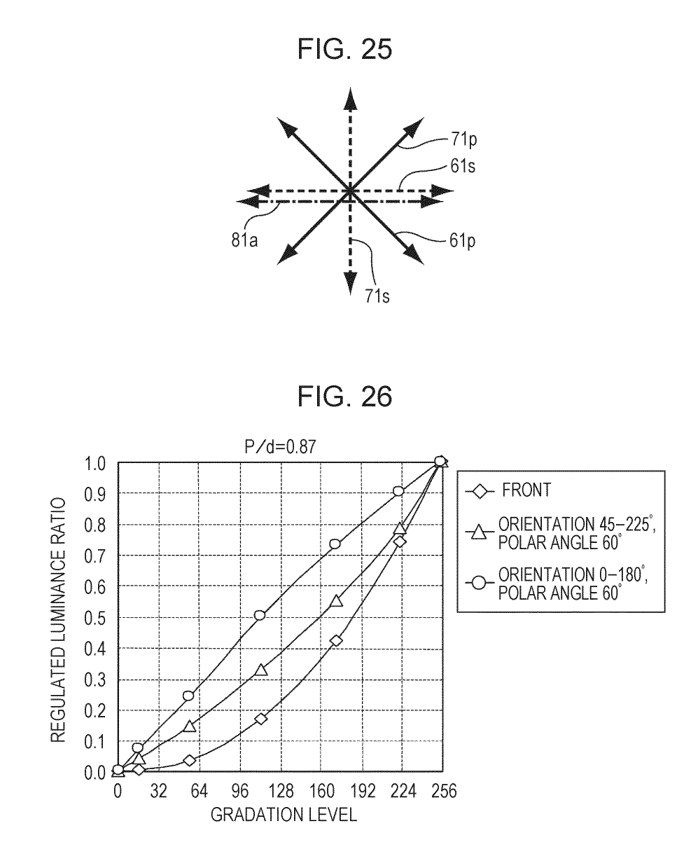

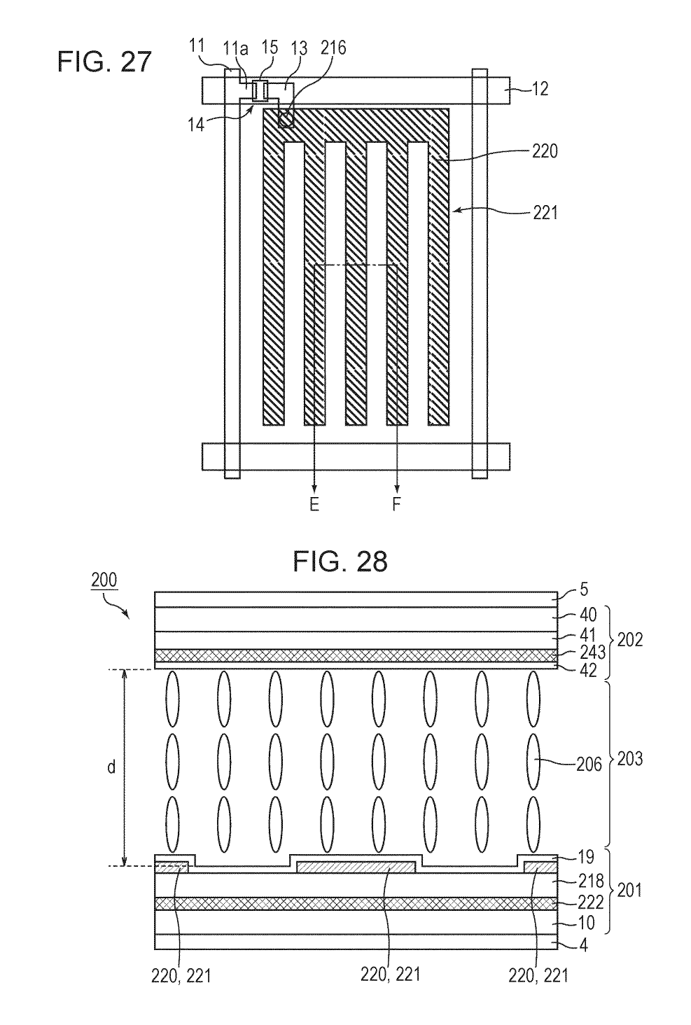

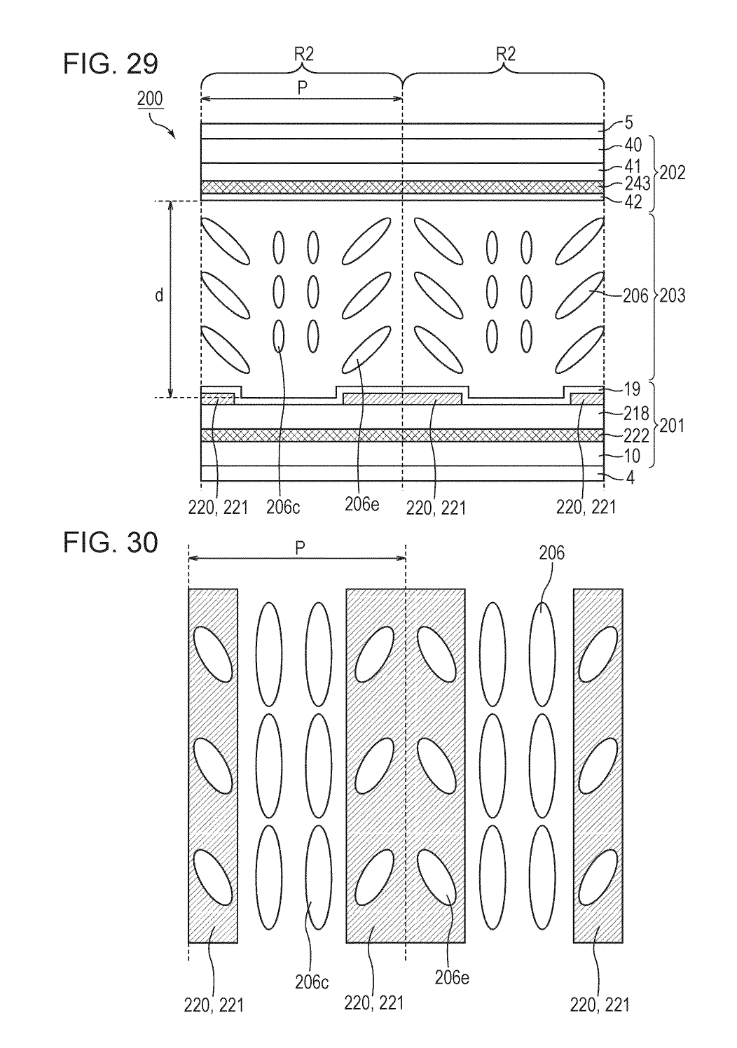

Next, the case where P/d is small will be described. Using the above-described pixel model for the simulation, the γ shift for a fifth sample where P/d=0.87 was calculated. Excluding the fact that P/d was changed, the fifth sample is the same as the first to fourth samples. In the fifth sample, as shown in FIG. 15, the domain axis 81a was along the absorption axis 71p. FIG. 24 shows the result.

Also, the γ shift of a sixth sample which is the same as the fifth sample excluding the fact that orientations of the optical axes were different was calculated. FIG. 25 shows the arrangement relationship of the optical axes of the polarizing plates of the sixth sample. In the polarizing plate 61, the absorption axis 61p of the linear polarizing plate and the in-plane slow axis 61s of the λ/4 plate were set to an orientation of 135° and an orientation of 180°, respectively. In the polarizing plate 71, the absorption axis 71p of the linear polarizing plate and the in-plane slow axis 71s of the λ/4 plate were set to an orientation of 45° and an orientation of 90°, respectively. The domain axis 81a remains as an orientation of 0°.

FIG. 26 shows the result. When FIGS. 24 and 26 are compared with each another, it was made clear that, when P/d becomes smaller, the γ shift becomes favorable if the domain axis is arranged in a direction parallel or orthogonal to the absorption axes of the polarizing plates. That is, it was made clear that the compensation of the viewing angle is not disturbed if the polarizing plates are arranged so that the liquid crystal molecules are hidden when viewed from the orientations of the absorption axes.

### Second Embodiment

Hereinafter, a liquid crystal display of a second embodiment will be described. Members that exert the same or similar functions as those in the first embodiment are given the same reference numerals, and detailed descriptions thereof are omitted. That is, various configurations of members whose descriptions are omitted are also applicable to the present embodiment.

As shown in FIG. 28, the liquid crystal display of the present embodiment includes a liquid crystal panel 200, a backlight unit (not shown) provided behind the liquid crystal panel 200, and a controller (not shown) that drives and controls the liquid crystal panel 200 and the backlight unit.

The liquid crystal panel 200 includes an active matrix substrate (TFT array substrate) 201 (hereinafter may simply be referred to as a substrate 201) corresponding to the above-described first substrate, an opposing substrate 202 (hereinafter may simply be referred to as a substrate 202) that corresponds to the above-described second substrate and that faces the substrate 201, a liquid crystal layer 203 sandwiched between these substrates, and a pair of polarizing plates 4 and 5 provided on the opposite side from the liquid crystal layer 203 of the substrates 201 and 202. The substrate 201 is provided on the back side of the liquid crystal display. The substrate 202 is provided on the observer side.

The substrates 201 and 202 are attached with a sealing member (not shown) provided to surround the display region. Also, the substrates 201 and 202 face each other via a spacer (not shown) such as a column-shaped spacer or the like. By filling the gap between the substrates 201 and 202 with a liquid crystal material, the liquid crystal layer 203 is formed as an optical modulation layer.

The active matrix substrate 201 includes an insulating substrate 10. As shown in FIGS. 27 and 28, on the main face on the liquid crystal layer 203 side of the insulating substrate 10, a plurality of gate bus lines 12, a plurality of source bus lines 11, thin-film transistors (TFTs) 14, pixel electrodes 220 (hereinafter may simply be referred to as electrodes 220) that correspond to the above-described first electrode and that are provided on the individual picture elements, a lower electrode 222 (hereinafter may simply be referred to as an electrode 222) that corresponds to the above-described second electrode and that is provided in common among all the picture elements, and a vertical alignment film 19 are formed. An image signal (voltage) is applied to the pixel electrodes 220. The lower electrode 222 is a common electrode, and a voltage common to all the picture elements is applied to the lower electrode 222.

The pixel electrodes 220 are comb electrodes. The pixel electrodes 220 each include a plurality of line-shaped portions 221 corresponding to teeth and a line-shaped portion (a shaft portion) connecting the line-shaped portions 221. As described above, the line-shaped portions 221 are straight line portions extending in the vertical direction in FIG. 27. However, as long as the pixel electrodes 220 and the lower electrode 222 can generate a desired electric field (such as a parabolic electric field), the shapes of the line-shaped portions 221 may be other shapes (such as V shape, broken line shape, or curve shape). The lower electrode 222 is planar and is formed without any gap, at least covering the entire display region, excluding regions where contact holes 216, described later, are formed.

When attention is paid to the sectional structure of the substrate 201, a first wiring layer, a gate insulating film (not shown) covering the first wiring layer, a semiconductor layer 15, a second wiring layer, a first insulating layer (not shown) covering the second wiring layer, the lower electrode 222, a second insulating layer 218, the pixel electrodes 220, and the vertical alignment film 19 are stacked in this order on the insulating substrate 10. The pixel electrodes 220 are electrically connected to the drain electrodes 13 of the TFTs 14 via the contact holes 216 penetrating through the first insulating layer and the second insulating layer 218.

The opposing substrate 202 includes an insulating substrate 40. A color filter layer 41, an opposing electrode 243 (hereinafter may simply be referred to as an electrode 243) corresponding to the above-described third electrode, and a vertical alignment film 42 are stacked in this order on the main face on the liquid crystal layer 3 side of the insulating substrate 40. The opposing electrode 243 is planar and is formed without any gap, at least covering the entire display region. Also, the opposing electrode 243 faces the pixel electrodes 220.

The liquid crystal layer 203 includes nematic liquid crystal molecules 206 whose dielectric constant anisotropy is negative. Due to the anchoring force of the vertical alignment films 19 and 42, the liquid crystal molecules 206 exhibit homeotropic alignment upon application of no voltage (when no electric field is generated by the above-described electrodes 220, 222, and 243), and the liquid crystal molecules 206 are aligned approximately in the vertical direction with respect to the main faces of the substrates 201 and 202. A pre-tilt angle of the liquid crystal layer 203 is greater than or equal to 86° (preferably greater than or equal to 88°) and less than or equal to 90°. When the pre-tilt angle is less than 86°, contrast may be reduced.

Since the liquid crystal panel 200 includes the pair of polarizing plates 4 and 5 arranged in cross-Nicol and includes the vertical alignment liquid crystal layer 203, the liquid crystal panel 200 is in a normally black mode.

The TFTs 14 are turned on only in a certain period in response to input of a scanning signal. While the TFTs 14 are turned on, the source bus lines 11 supply an image signal to the pixel electrodes 220 at a certain timing. That is, a voltage in accordance with the image signal is applied to the pixel electrodes 220.

In contrast, the opposing electrode 222 is an electrode (common electrode) for applying a common voltage to all the picture elements, and a certain voltage (AC voltage or DC voltage, such as 0 V) is applied to the opposing electrode 222. The opposing electrode 243 is also a common electrode, and a certain voltage (AC voltage or DC voltage, such as 0 V) is applied to the opposing electrode 243.

Upon application of an image signal (voltage) to the pixel electrodes 220 (hereinafter may also be referred to as upon application of voltage), an electric field is generated between the pixel electrodes 220 and the opposing electrode 222, which is directed from the pixel electrodes 220 to the opposing electrode 222, and between the pixel electrodes 220 and the opposing electrode 243, which is directed from the pixel electrodes 220 to the opposing electrode 243. Due to these electric fields, the liquid crystal molecules 206 fall down. Thus, the retardation of the liquid crystal layer 203 changes, and the transmittance of each picture element changes. As a result, an image is displayed.

Hereinafter, the alignment state of the liquid crystal molecules 206 upon application of voltage will be described in detail. When a voltage is applied to the pixel electrodes 220, a parabolic electric field directed from the pixel electrodes 220 to the opposing electrode 222 and a vertical electric field directed from the pixel electrodes 220 to the opposing electrode 243 are generated. Since the dielectric constant anisotropy of the liquid crystal molecules 206 is negative, the liquid crystal molecules 206 tend to be aligned in a direction orthogonal to the electric line of force of a horizontal electric field. As a result, as shown in FIGS. 29 and 30, the liquid crystal molecules 206 fall down in a direction approximately parallel to the main faces of the substrates 201 and 202. Liquid crystal molecules 206c between the line-shaped portions 221 are aligned in the longitudinal direction of the line-shaped portions 221. In contrast, liquid crystal molecules 206e on the line-shaped portions 221 are aligned, tilted a little with respect to the longitudinal direction of the line-shaped portions 221 in a state where the liquid crystal panel 200 is viewed in plane. Also, the tilt angle of the liquid crystal molecules 206e is smaller than that of the liquid crystal molecules 206c in a state where the liquid crystal panel 200 is viewed in cross section.

As a result, upon application of voltage, a regular alignment distribution is generated in a region R2 that is a region between the center lines of the line-shaped portions 221. Also, the liquid crystal molecules 6 with different tilt angles exist in the region R2. In the region R2, the liquid crystal molecules 206 are symmetrically aligned with respect to a center line passing the center between the line-shaped portions 221 (actually a face (virtual face), which extends in a direction parallel to the line-shaped portions 221). That is, two domains are generated in the region R2. As described above, in the region R2 where the liquid crystal molecules 206 are symmetrically aligned, complementary alignment compensation can be achieved according to the same principle as that in the first embodiment.

Also in the present embodiment, the smaller the ratio P/d between the pitch P of the region R2, that is, the pitch P between the center lines of the line-shaped portions 221, and the cell thickness d becomes, the more improvement in the diagonal viewing angle can be achieved. P/d<3 is set. Therefore, the viewing angle characteristics can be improved than before.

Hereinafter, the liquid crystal panel 200 and each member will be further described.

It is preferable that the widths of the line-shaped portions 221 be as thin as possible. From the viewpoint of preventing the occurrence of defects such as broken wires, it is preferable that the widths of the line-shaped portions 221 be 3 μm (more preferably 2 μm) or greater. The widths of the line-shaped portions 221 may be different from each other.

The cell thickness d is about 2.8 to 4.5 μm (preferably 3.0 to 3.4 μm). It is preferable that the product (panel retardation) of the cell thickness d and the refractive index anisotropy Δn (value corresponding to light with wavelength λ) of the liquid crystal material satisfy approximately 2/2. Specifically, it is preferable that 280≦dΔn≦450 nm be satisfied, and it is more preferable that 280≦dΔn≦340 nm be satisfied.

The second insulating layer 218 is formed of a transparent insulating material, specifically, for example, an inorganic insulating film such as oxide silicon or nitride silicon or an organic insulating film such as acrylic resin. The film thickness of the second insulating layer is about 0.1 to 3.2 μm. As the second insulating layer 218, an insulating film that is formed from SiN and that has a film thickness of about 0.1 to 0.3 μm or an insulating film that is formed from acrylic resin and that has a film thickness of about 1 to 3.2 μm is preferable. A plurality of layers may be stacked as the second insulating layer 218. In this case, the materials of the plurality of layers may be different from one another. For example, the second insulating layer 218 may be a multilayer body including an inorganic insulating film and an organic insulating film. As the material of the pixel electrodes 220 and the opposing electrodes 222 and 243, a translucent conductive material is preferable. Among such materials, metal oxide such as indium tin oxide (ITO) or indium zinc oxide (IZO) is preferably used.

The present application is based on and claims priority under the Paris Convention and provisions of national law in a designated State from Japanese Patent Application No. 2010-293851 filed Dec. 28, 2010, the entire contents of which are hereby incorporated by reference.

### REFERENCE SIGNS LIST

1, 201: active matrix substrates
2, 202: opposing substrates
3, 203: liquid crystal layers
4, 5: polarizing plates
4p, 5p: absorption axes
4s, 5s: in-plane slow axes
6, 6c, 6e, 206, 206c, 206e: liquid crystal molecules
6a: domain axis
8, 9: dark lines
10, 40: insulating substrates
11: source bus lines
11a: source electrodes
12: gate bus lines
13: drain electrodes
14: TFTs
15: semiconductor layer
16, 216: contact holes
19, 42: vertical alignment films
20, 220: pixel electrodes
21, 23, 221: line-shaped portions
22, 222, 243: opposing electrodes
41: color filter layer
100, 200: liquid crystal panels
218: second insulating layer
R1, R2: regions (complementary alignment compensation regions)
d: cell thickness
P: pitch

1. A liquid crystal panel of a vertical alignment type, the liquid crystal panel comprising a first substrate, a second substrate facing the first substrate, and a liquid crystal layer that is sandwiched between the first substrate and the second substrate and that includes liquid crystal molecules,
wherein the first substrate includes a first electrode including a plurality of first line-shaped portions arranged side by side with a gap,
wherein the first substrate or the second substrate includes a second electrode,
wherein the liquid crystal layer is driven by an electric field generated by at least the first electrode and the second electrode, and
wherein D/d<3 is satisfied where D is the distance between center lines of the plurality of first line-shaped portions and d is the cell thickness of the liquid crystal panel.

2. The liquid crystal panel according to claim 1, wherein the liquid crystal molecules are symmetrically aligned with respect to a certain face upon application of voltage.

3. The liquid crystal panel according to claim 1,
wherein the first substrate includes the second electrode,
wherein the second electrode includes a plurality of second line-shaped portions arranged side by side with a gap, and
wherein the first line-shaped portions and the second line-shaped portions are alternately arranged.

4. The liquid crystal panel according to claim 3, wherein the first electrode and the second electrode each include a comblike shape.

5. The liquid crystal panel according to claim 3, wherein dielectric constant anisotropy of the liquid crystal molecules is positive.

6. The liquid crystal panel according to claim 3, wherein D/d>1.5 is satisfied.

7. The liquid crystal panel according to claim 1,
wherein the first substrate includes the second electrode and an insulating layer provided between the first electrode and the second electrode,
wherein the second electrode is planar,
wherein the second substrate includes a planar third electrode, and
wherein the second electrode is superimposed on the gap.

8. The liquid crystal panel according to claim 7, wherein the first electrode includes a comblike shape.

9. The liquid crystal panel according to claim 7, wherein dielectric constant anisotropy of the liquid crystal molecules is negative.

10. The liquid crystal panel according to claim 1, wherein the liquid crystal panel further comprises a circular polarizing plate.

11. The liquid crystal panel according to claim 10, wherein the optical axis of the circular polarizing plate is orthogonal or parallel to the plurality of first line-shaped portions.

12. The liquid crystal panel according to claim 1, wherein the liquid crystal panel further comprises a linear polarizing plate.

13. The liquid crystal display comprising the liquid crystal panel according to claim 1.
